(19) United States
(12) Patent Application Publication
(10) Pub. No.: US 2011/0109295 A1
(43) Pub. Date: May 12, 2011

(54) SEMICONDUCTOR DEVICE AND DC-DC CONVERTER

(75) Inventors: Daisuke Minohara, Hyogo-ken (JP); Kazutoshi Nakamura, Kanagawa-ken (JP)

(73) Assignee: KABUSHIKI KAISHA TOSHIBA, Tokyo (JP)

(21) Appl. No.: 12/886,902

(22) Filed: Sep. 21, 2010

(30) Foreign Application Priority Data
Nov. 9, 2009 (JP) 2009-256552

(51) Int. Cl. G05F 3/08

(52) U.S. Cl. 323/311

(57) ABSTRACT

According to one embodiment, a semiconductor device includes a first switching element and a second switching element. The first switching element has a first threshold voltage and a first gate electrode connected to a first gate wiring. The second switching element has a second threshold voltage and a second gate electrode connected to a second gate wiring. The second threshold voltage has a larger absolute value than the first threshold voltage. The second gate wiring has a larger resistance per unit length than the first gate wiring.

### CROSS-REFERENCE TO RELATED APPLICATIONS

This application is based upon and claims the benefit of priority from the prior Japanese Patent Application No. 2009-256552, filed on Nov. 9, 2009; the entire contents of which are incorporated herein by reference.

### FIELD

Embodiments described herein relate generally to a semiconductor device and a DC-DC converter.

### BACKGROUND

A step-down DC-DC converter is used for a personal computer and the like. A synchronous rectification type DC-DC converter with high power conversion has been used along with reduction in voltage and increase in current in large scale integration (LSI) and the like. Moreover, for reduction in size and for lowering parasitic inductance of a DC-DC converter circuit, a one-chip configuration is becoming more mainstream.

Such a configuration includes: a high-side metal oxide semiconductor field effect transistor (MOSFET) for switching (chopping) a voltage on a primary side at a certain duty ratio and transmitting the resultant voltage to a secondary side; a low-side MOSFET for returning an output current when the high-side MOSFET is OFF; and a driver circuit including a MOSFET for driving the above MOSFETs (for example, refer to JP-A 2009-022106 (Kokai)). There is also a configuration further including a control circuit in addition to the above.

In the synchronous rectification type DC-DC converter, the circuit is short-circuited when the high-side MOSFET and the low-side MOSFET are simultaneously turned on. To avoid this, there is provided a period of time, called a dead time, in which the high-side MOSFET and the low-side MOSFET are both OFF.

During the period from the turning-off of the high-side MOSFET to the turning-on of the low-side MOSFET, most of a return current flows through a built-in diode in the low-side MOSFET. The rest of the current flows through a MOS diode in the MOSFET. In this event, the electronic current flowing through the built-in diode is partially injected into the substrate. The injected electronic current may be lost by flowing to the high-side when the high-side MOSFET is turned on, or may cause an error in the driver circuit or the control circuit by flowing into these circuits through the substrate.

Lowering a threshold voltage (Vth) of the low-side MOSFET is effective in reducing the electronic current injected into the substrate. This is because the current flowing through the MOS diode is increased with the reduction in threshold current. However, when the threshold voltage of the low-side MOSFET is lowered, self turn-on is likely to occur, in which the low-side MOSFET is erroneously turned on when the high-side MOSFET is turned on.

When the high-side MOSFET is turned on while the low-side MOSFET is off, an abrupt change in voltage occurs between a drain and a source of the low-side MOSFET. This change in voltage causes a displacement current to flow through a gate-drain capacitance. This displacement current flows from the gate electrode of the low-side MOSFET through an N-channel MOSFET in the driver circuit to the ground potential (GND) of the DC-DC converter, and causes an increase in a gate voltage of the low-side MOSFET. The self turn-on means a phenomenon in which the low-side MOSFET is turned on when this increase in the gate voltage exceeds the threshold voltage. The self turn-on causes a pass-through current to flow through the high-side MOSFET and the low-side MOSFET, thus causing a significant loss.

### BRIEF DESCRIPTION OF THE DRAWINGS

FIG. 1 is a main part circuit diagram of a semiconductor device according to an embodiment;

FIGS. 2A to 2C are diagrams of a DC-DC converter according to the embodiment, where FIG. 2A is a main part circuit diagram of the DC-DC converter, FIG. 2B is a schematic cross-sectional diagram of the semiconductor device including a low-side switching element and a driver circuit in the DC-DC converter, and FIG. 2C is a main part circuit diagram of the switching element and the driver circuit;

FIGS. 3A to 3C are diagrams of a DC-DC converter according to a comparative example, where FIG. 3A is a main part circuit diagram of the DC-DC converter, FIG. 3B is a schematic cross-sectional diagram of a low-side switching element and a driver circuit in the DC-DC converter, and FIG. 3C is a main part circuit diagram of the switching element and the driver circuit;

FIG. 4 is a plan view of a semiconductor device according to the embodiment;

FIG. 5A is an A-A′ cross-section of FIG. 4, and FIG. 5B is a B-B′ cross-section of FIG. 4;

FIG. 6 is a main part enlarged plan view of the semiconductor device in a region 90L of FIG. 4;

FIG. 7 is a plan view of a variation example of the semiconductor device according to the embodiment;

FIG. 8 is a plan view of a variation example of the semiconductor device according to the embodiment;

FIG. 9 is a main part plan view of a variation example of the semiconductor device according to the embodiment; and

FIG. 10 is an equivalent circuit diagram included a driver circuit.

### DETAILED DESCRIPTION

In general, according to one embodiment, a semiconductor device includes a first switching element and a second switching element. The first switching element has a first threshold voltage and a first gate electrode connected to a first gate wiring. The second switching element has a second threshold voltage and a second gate electrode connected to a second gate wiring. The second threshold voltage has a larger absolute value than an absolute value of the first threshold voltage. The second gate wiring has a larger resistance per unit length than a resistance per unit length of the first gate wiring.

According to another embodiment, a DC-DC converter includes a low-side semiconductor device, a fifth high-side switching element, an inductor, and a capacitor. The low-side semiconductor device includes a first switching element and a second switching element. The first switching element has a first threshold voltage and a first gate electrode connected to a first gate wiring. The second switching element has a second threshold voltage and a second gate electrode connected to a second gate wiring. The second threshold voltage has a larger absolute value than an absolute value of the first threshold voltage. The second gate wiring has a larger resistance per unit length than a resistance per unit length of the first gate wiring. The fifth high-side switching element is connected in series to the semiconductor device. The inductor has one end side connected between the semiconductor device and the fifth switching element. The capacitor is connected to one other end side of the inductor.

With reference to the drawings, embodiments of the invention are described below. In the following description, an embodiment is described by taking a synchronous rectification step-down DC-DC converter as an example. First, outlines of a semiconductor device according to this embodiment and a DC-DC converter including the semiconductor device are described.

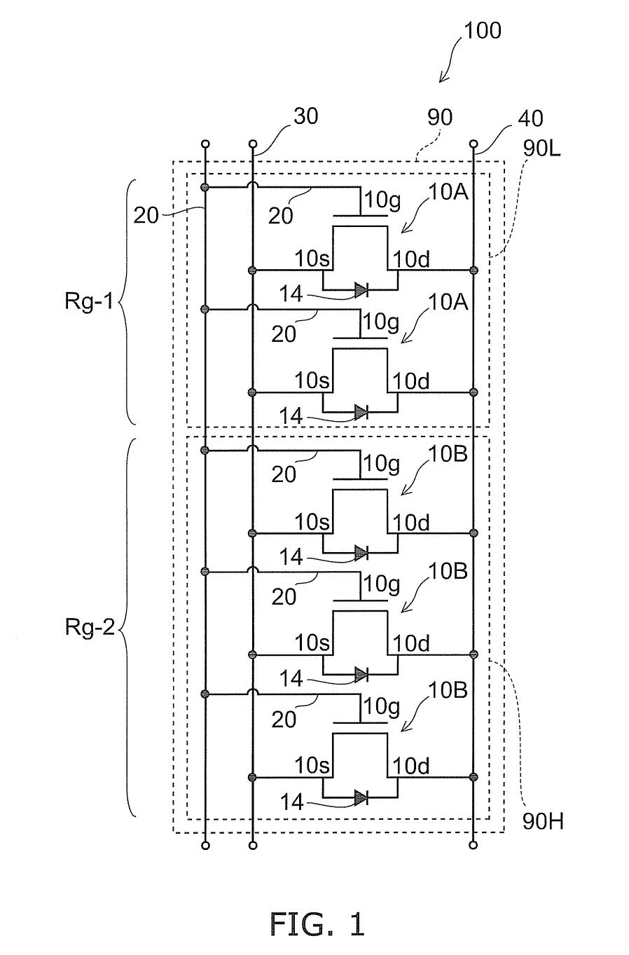

FIG. 1 is a main part circuit diagram of the semiconductor device according to this embodiment.

A semiconductor device 100 includes switching elements 10A and 10B of multiple MOSFETs (field-effect transistors). These multiple switching elements 10A and 10B have gate electrodes 10g connected to common gate wirings 20. Each of the switching elements 10A and 10B has a source region 10s and a drain region 10d connected in parallel. A built-in diode 14 is formed in each of the switching elements 10A and 10B. The source regions 10s and the drain regions 10d are connected in parallel by wirings 30 and 40. Thus, currents flowing through the switching elements 10A and 10B merge into the wirings 30 and 40. Thereby, a large current flows through the semiconductor device 100.

A region 90 in which the multiple switching elements 10A and 10B are disposed includes a first region 90L and a second region 90H. First switching elements 10A each having a first threshold voltage are disposed in the first region 90L, and second switching elements 10B each having a second threshold voltage are disposed in the second region 90H. Here, the absolute value of the first threshold voltage is smaller than the absolute value of the second threshold voltage. Moreover, of the common gate wirings 20, a resistance Rg-1 is a resistance of a gate wiring per unit length of a portion connected to the first switching element 10A having the first threshold voltage, a resistance Rg-2 is a resistance of a gate wiring per unit length of a portion connected to the second switching element 10B having the second threshold voltage, and the resistance Rg-1 is smaller than the resistance Rg-2.

Thus, when a gate wiring having the resistance Rg-1 is a first gate wiring and a gate wiring having the resistance Rg-2 is a second gate wiring, the semiconductor device 100 includes the first switching elements 10A having the first threshold voltage and the gate electrodes 10g connected to the first gate wirings. The semiconductor device 100 further includes the second switching elements 10B having the second threshold voltage larger in absolute value than the first threshold voltage and having the gate electrodes connected to the second gate wirings having the resistance per unit length larger than that of the first gate wirings. These first and second switching elements 10A and 10B are controlled by a driver circuit described below. More detailed structure and advantageous effects of the semiconductor device 100 are described below.

Next, a DC-DC converter 200 including the semiconductor device 100 is described. First, the structure and operations of the DC-DC converter are described.

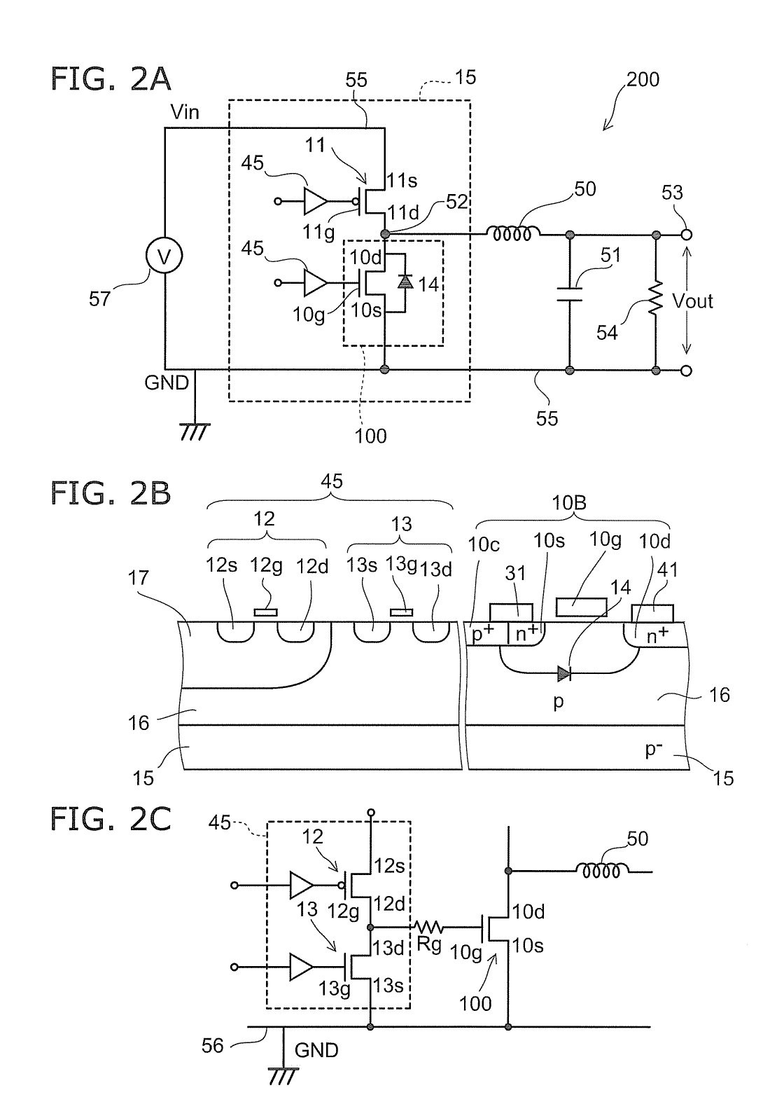

FIGS. 2A to 2C are main part diagrams of the DC-DC converter according to this embodiment. FIG. 2A shows a main part circuit diagram of the DC-DC converter 200 according to this embodiment. FIG. 2B shows a schematic cross-sectional structure of the switching element 10B and a driver circuit 45 in the DC-DC converter 200. FIG. 2C shows a main part circuit diagram of the switching element 10 and the driver circuit 45 in the DC-DC converter 200.

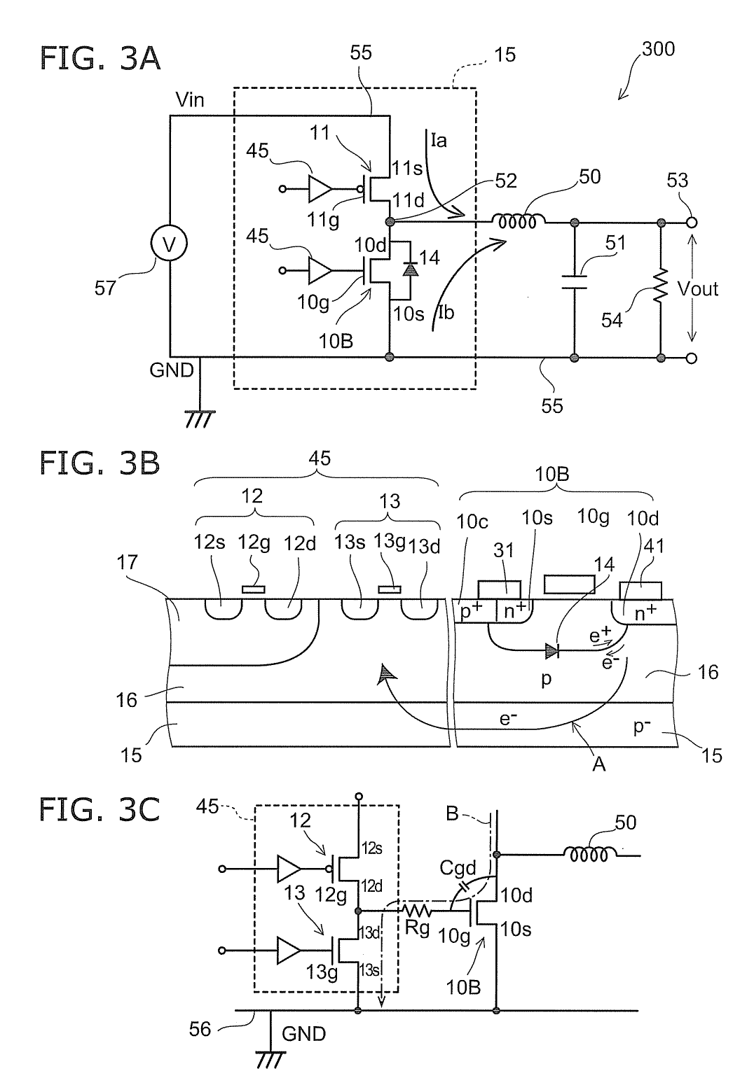

FIGS. 3A to 3C are main part diagrams of a DC-DC converter according to a comparative example. FIG. 3A shows a main part circuit diagram of a DC-DC converter 300 of the comparative example. FIG. 3B shows a schematic cross-sectional structure of a switching element 10B and a driver circuit 45 in the DC-DC converter 300. FIG. 3C shows a main part circuit diagram of the switching element 10 and the driver circuit 45 in the DC-DC converter 300.

The DC-DC converter 200 according to this embodiment includes the driver circuit 45 and the semiconductor device 100 serving as a low-side switching element. The DC-DC converter 300 does not have the semiconductor device 100. All of the low-side switching elements of the DC-DC converter 300 are the switching element 10B described above. The rest of the structure of the DC-DC converter 300 is the same as that of the DC-DC converter 200.

As shown in FIG. 2A, the DC-DC converter 200 according to this embodiment includes the driver circuit 45, a high-side switching element 11, the semiconductor device 100 serving as the low-side switching element, an inductor 50 such as a coil, for example, and a capacitor 51.

A gate electrode 11g of the high-side switching element 11 and the gate electrode 10g of the semiconductor device 100 serving as the low-side switching element are connected to the driver circuit 45, respectively. The driver circuit 45 functions to turn on and off the semiconductor device 100 and the switching element 11. The switching element 11 is, for example, a P-channel type, and the switching elements 10A and 10B of the semiconductor device 100 are, for example, an N-channel type. The switching elements 10A, 10B, and 11 are, for example, lateral power MOSFETs.

For example, one end side of the inductor 50 is connected to a connection point (a node 52) between a drain electrode connected to a drain region lid of the high-side switching element 11 and a drain electrode connected to the drain region 10d of the semiconductor device 100 serving as the low-side switching element. The other end side of the inductor 50 is connected to an output terminal 53. The capacitor 51 is also connected to the other end side of the inductor 50, and a reference potential (e.g., a ground potential GND) is supplied through the capacitor 51 to the other end side of the inductor 50. A source electrode is connected to the reference potential (GND), and the source electrode is connected to the source region 10s of the semiconductor device 100 serving as the switching element. Further, a power source 57 is provided between a source region 11s of the switching element 11 and the source region 10s of the semiconductor device 100. The power source 57 inputs an input voltage Vᵢₙ to the source region 11s of the switching element 11, and an output voltage Vₒᵤₜ is outputted from the output terminal 53. The built-in diode 14 is formed between the drain region 10d and the source region 10s of the semiconductor device 100. The driver circuit 45, the semiconductor device 100, and the switching element 11 are formed on the same substrate (semiconductor substrate) 15 surrounded by a broken line to achieve a high-speed operation.

FIG. 2B shows part of the cross-sections of the switching element 10B and the driver circuit 45, which are formed on the substrate 15. In a formation region of the switching element 10B, a P type base region (P type well region) 16 is formed in the P⁻ type substrate 15. In a surface of the P type base region 16, an N⁺ type source region 10s, a P⁺ type contact region 10c, and an N⁺ type drain region 10d are formed. The source electrode 31 is connected to the source region 10s and the contact region 10c. A drain electrode 41 is connected to the drain region 10d. The switching element 10B further includes the built-in diode 14 having of the P⁺ type contact region 10c, the P type base region 16, and the N⁺ type source region 10s.

Further, the driver circuit (inverter circuit) 45 having a CMOS structure is formed on the same substrate 15. For example, a switching element 12 of a P-channel MOSFET and a switching element 13 of an N-channel MOSFET are provided on the substrate 15.

In a formation region of the switching element 12, an N type base region (N type well region) 17 is provided in the substrate 15. In a surface of the N type base region 17, a P⁺ type source region 12s and a P⁺ type drain region 12d are provided. A gate electrode 12g is provided on the base region 17 between the source region 12s and the drain region 12d. Further, in a formation region of the switching element 13, an N⁺ type source region 13s and an N⁺ type drain region 13d are provided in the surface of the base region 16. A gate electrode 13g is provided on the base region 16 between the source region 13s and the drain region 13d. A signal is supplied to each of the gate electrodes 12g and 13g from a control circuit (not shown in FIGS. 2A to 2C). The drain regions 12d and 13d are connected to the gate electrode 10g of the semiconductor device 100 (see FIG. 2C).

Next, operations of the DC-DC converter are described using the DC-DC converter 300 of the comparative example shown in FIG. 3A.

The DC-DC converter 300 is a step-down DC-DC converter which outputs an output voltage Vₒᵤₜ lower than an input voltage Vᵢₙ by alternately turning on and off the switching element 10B and the switching element 11.

The driver circuit 45 supplies a gate drive signal (switching pulse) to the gate electrodes 10g and 11g of the switching elements 10B and 11. The driver circuit 45 has a complementary metal oxide semiconductor (CMOS) structure as described above.

When the switching elements 10B and 11 are driven by the driver circuit 45, a square wave, for example, is outputted to the connection point (node 52) of the two switching elements 10B and 11 connected in series between an input source of the input voltage Vᵢₙ and the reference potential (GND). The square wave is smoothed by a filter including the inductor 50 and the capacitor 51, and the output voltage Vₒᵤₜ is obtained at an electric load 54.

For controlling ON/OFF of the switching elements 10B and 11, the driver circuit 45 supplies the switching pulse having an almost inverted phase to the respective gate electrodes 10g and 11g of the switching elements 10B and 11.

When the switching element 11 is ON and the switching element 10B is OFF, a current Ia flows through the switching element 11 to the inductor 50, the inductor current is increased, and energy is accumulated in the inductor 50. During the period between turning off the switching element 11 and turning on the switching element 108, a return current Ib flowing through the switching element 10B (flowing mainly through the built-in diode 14) from the reference potential is generated by the energy (counter electromotive force) accumulated in the inductor 50. Here, the capacitor 51 functions as a low-pass filter to reduce output ripple noise resulting from a fluctuation in the current flowing through the inductor 50. A switching duty ratio of the switching elements 10B and 11 determines how much the output voltage Vₒᵤₜ drops in relation to the input voltage Vᵢₙ.

When both of the switching elements 10B and 11 are simultaneously turned on, a large current flows from an input terminal 55 through the switching element 11 and also through the switching element 10B to a ground 56. To avoid such a situation, the switching element 10B is turned on after a short time passes after turning off the switching element 11. This short time is called a “dead time.”

However, during the dead time, the current flowing through the built-in diode 14 may be partially injected into the substrate 15 that is the base of the switching element 10B. This electronic current injected into the substrate 15 tends to be increased along with an increase in the output current.

The injected electronic current may sometimes act as a reverse current when the switching element 11 is ON. In such a case, a switching loss occurs, and thus conversion efficiency of the DC-DC converter is decreased. Moreover, the injected electronic current may sometimes flow into the driver circuit 45. For example, FIG. 3B shows a phenomenon in which the electronic current is injected into the substrate 15 and flows into the CMOS, i.e., the driver circuit 45 (see the arrow A). Such a phenomenon triggers an error in the driver circuit 45. Further, a similar phenomenon occurs in a control circuit which controls the driver circuit 45, and similarly triggers an error therein.

Incidentally, it is not limited that all the current flowing through the drain region 10d during the dead time is conducted through the built-in diode 14. For example, it is known that a part of the return current Ib flows through a portion of the switching element 10B where a channel is formed (hereinafter simply referred to as a channel portion).

The amount of the current flowing through the channel portion is affected by the threshold voltage (Vth) of the switching element 10B. For example, the rate of the current flowing through the channel portion of the switching element 10B can be increased by setting the absolute value of the threshold voltage (Vth) of the switching element 10B lower. In other words, setting the absolute value of the threshold voltage (Vth) of the switching element 10B low is effective in suppressing carriers to be injected into the substrate 15.

However, lowering the absolute value of the threshold voltage (Vth) of the switching element 10B makes self turn-on likely to occur when the high-side switching element 11 is ON. This self turn-on causes the current to flow from the drain region 10d of the switching element 10B through the gate electrode 10g and the channel portion of the N-channel switching element 13 in the driver circuit 45 (see the dashed wavy line indicated by an arrow B in FIG. 3C). As a result, the voltage of the gate wiring of the switching element 10B is changed. This may increase the gate voltage of the switching element 10B to the threshold voltage or higher and thus (erroneously) turn on the switching element 10B.

However, the self turn-on is unlikely to occur when the following relational expression is established:

(Rg+Rdrive)×Cgd×(dv/dt)<Vth Expression (1)

wherein dv/dt is an amount of change in the drain voltage of the switching element 10B, Cgd is a capacitance between the gate electrode 10g and the drain region 10d, Rg is a gate resistance, and Rdrive is an on-resistance of the switching element 10B.

Accordingly, in the DC-DC converter 200 of this embodiment shown in FIG. 2A, the semiconductor device 100 is included as the switching element. A region having a smaller absolute value of the threshold voltage (Vth) and a lower gate resistance Rg is provided selectively provided in a region where the multiple switching elements are provided on the substrate 15. Thereby, injection of the carriers into the substrate 15 and the self turn-on are suppressed.

A specific example of the structure of the semiconductor device 100 included in the DC-DC converter 200 is described below. In the following description, components similar to those illustrated in FIG. 1 and FIGS. 2A to 2C are marked with like reference numerals, and a description thereof is omitted as appropriate.

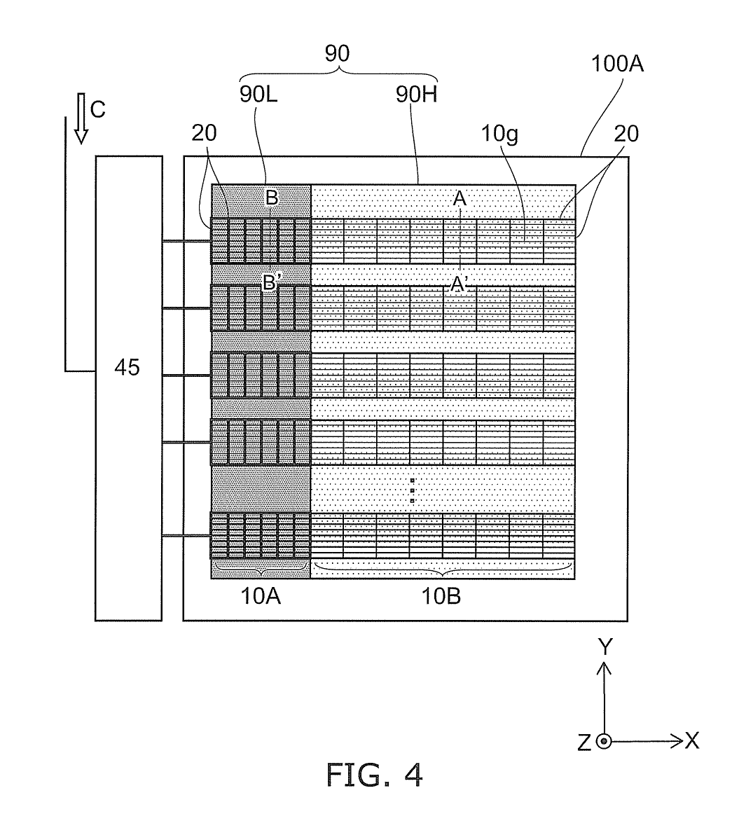

FIG. 4 to FIG. 6 are main part diagrams of a semiconductor device according to this embodiment.

First, FIG. 4 is a plan view of the semiconductor device and shows an arrangement of multiple switching elements 10A and 10B.

A semiconductor device 100A includes the switching elements 10A each having a small absolute value of threshold voltage (Vth). And the semiconductor device 100A includes the switching elements 10B each having an absolute value of threshold voltage (Vth) larger than that of the switching element 10A. For example, as shown in FIG. 4, the switching elements are provided in a region 90. The region 90 includes: a region 90L in which the switching elements 10A each having a small absolute value of threshold voltage (Vth) are disposed; and a region 90H in which the switching elements 10B each having a large absolute value of threshold voltage (Vth) are disposed. Particularly, the switching elements 10A having a small absolute value of threshold voltage (Vth) are disposed nearby the driver circuit 45. A control signal to be inputted to the driver circuit 45 is indicated by an arrow C.

The level of the absolute value of threshold voltage (Vth) can be determined by adjusting, for example, an impurity concentration of the channel.

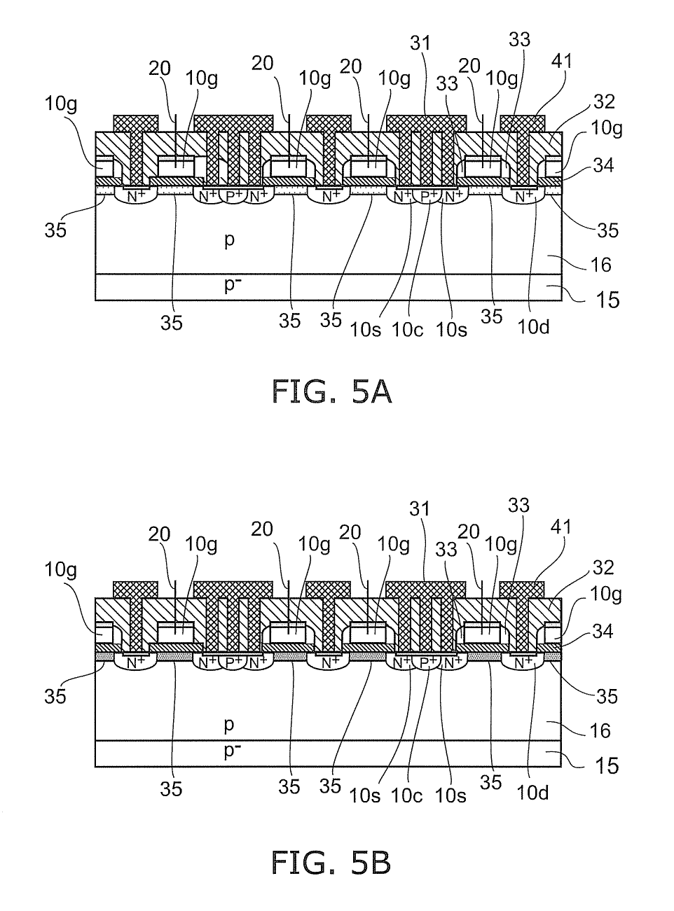

For example, FIG. 5A shows an A-A′ cross-section of FIG. 4, and FIG. 5B shows a B-B′ cross-section of FIG. 4. FIGS. 5A and 5B illustrate an interlayer insulating film 32, a sidewall protective film 33, and a gate oxide film 34 in addition to the components illustrated in FIG. 3B. Specifically, FIG. 5A shows the switching elements 10B, and FIG. 5B shows the switching elements 10A. In FIGS. 5A and 5B, higher the impurity concentration of the channel portion 35 is, darker the shading is. As shown in the drawings, the impurity concentration of the channel portion 35 shown in FIG. 5B is higher than the impurity concentration of the channel portion 35 shown in FIG. 5A.

Referring back to FIG. 4, the semiconductor device 100A is described.

A gate wiring 20 laid out in the region 90L has a small absolute value of threshold voltage (Vth). A gate wiring 20 laid out in the region 90H has a large absolute value of threshold voltage (Vth). The gate wiring 20 in the region 90L has a width larger than that of a gate wiring 20 in the region 90H. Further, the number of the gate wirings 20 in the region 90L is larger than that in the region 90H. Accordingly, a resistance (gate resistance Rg) per unit length of the gate wirings 20 laid out in the region 90L is smaller than that of the gate wirings 20 laid out in the region 90H.

Therefore, in the semiconductor device 100A, at least part of the multiple switching elements has a small absolute value of threshold voltage (Vth) and a low gate resistance Rg. Other than the line width, the resistance of the gate wirings 20 may be adjusted by the thickness thereof.

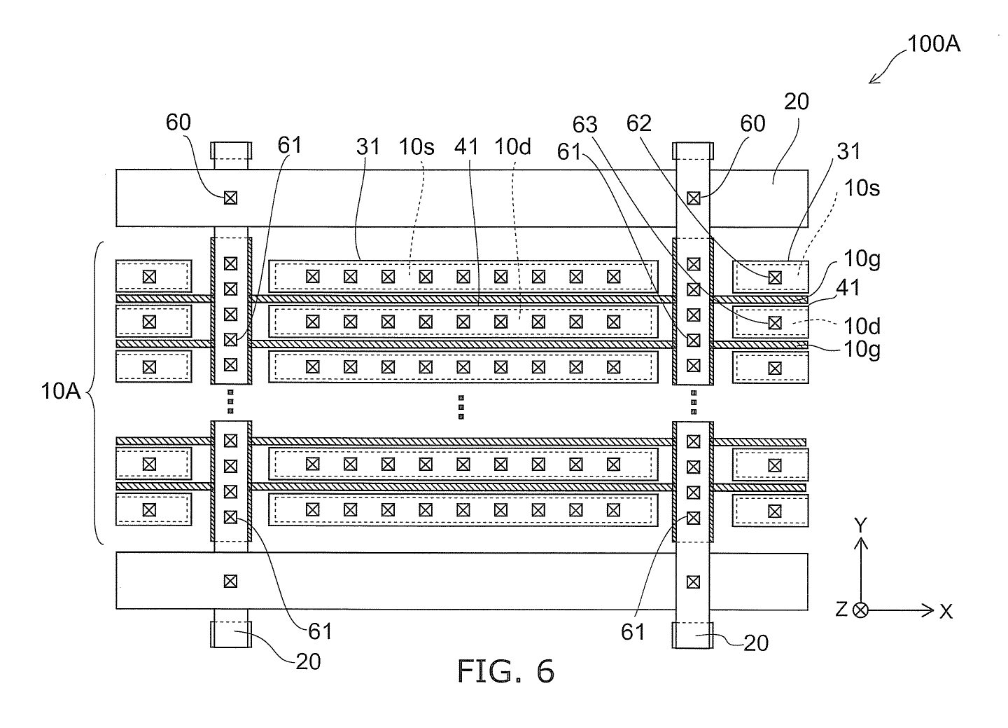

FIG. 6 is an enlarged view of a main part plan of the semiconductor device in the region 90L.

As shown in FIG. 6, the gate wirings 20 are periodically laid out in an X direction of the semiconductor device 100A and in a Y direction approximately perpendicular to the X direction. The gate wirings 20 are electrically connected to each other through contact holes 60. That is, the gate wirings 20 are common wirings. Moreover, the gate wirings 20 extended in the Y direction are connected to gate electrodes 10g through contact holes 61. The gate electrodes 10g extend in the X direction and are periodically disposed along the Y direction. A source region 10s and a drain region 10d of the switching element 10A are disposed on both sides of each of the gate electrodes 10g. A source electrode 31 is connected to the source region 10s through a contact hole 62. A drain electrode 41 is connected to the drain region 10d through a contact hole 63. The source electrodes 31 and the drain electrodes 41, which are alternately arranged, are respectively connected to common wirings (not shown) outside the semiconductor device 100A. In FIG. 6, the illustration of contact regions 10c is omitted. Also, the width of the gate wirings 20 in the region 90H described above is smaller than the width of the gate wirings 20 shown in FIG. 6.

According to the semiconductor device 100A described above, the region 90L in which the absolute value of the threshold voltage (Vth) of the switching elements is set to be small is provided. Thus, as described above, injection of electronic current into the substrate 15 is suppressed. Particularly, in this embodiment, the absolute value of the threshold voltage (Vth) of the switching elements 10A disposed nearby the driver circuit 45 is set to be lowered. Accordingly, injection of electronic current into the driver circuit 45 is efficiently suppressed. Further, the gate resistance Rg of the switching elements 10A in the region 90L is set to be lower than that in the region 90H. Thus, self turn-on is suppressed. Generally, the farther away from the driver circuit 45, the larger the gate wiring resistance becomes. In this embodiment, however, because the gate resistance nearby the driver circuit 45 is lowered, the gate resistance is effectively reduced. For this reason, the use of the semiconductor device 100A improves power conversion efficiency of the DC-DC converter.

As a way to lower the resistance of gate wirings, there is a method of increasing the width of all the gate wirings 20 in the region 90. However, the increase in the width of all the gate wirings 20 in the region 90 leads to an increase in an ineffective region of the switching elements. Therefore, it is preferable, as in this embodiment, to selectively provide a region in which the gate resistance Rg of the switching elements is set to be low.

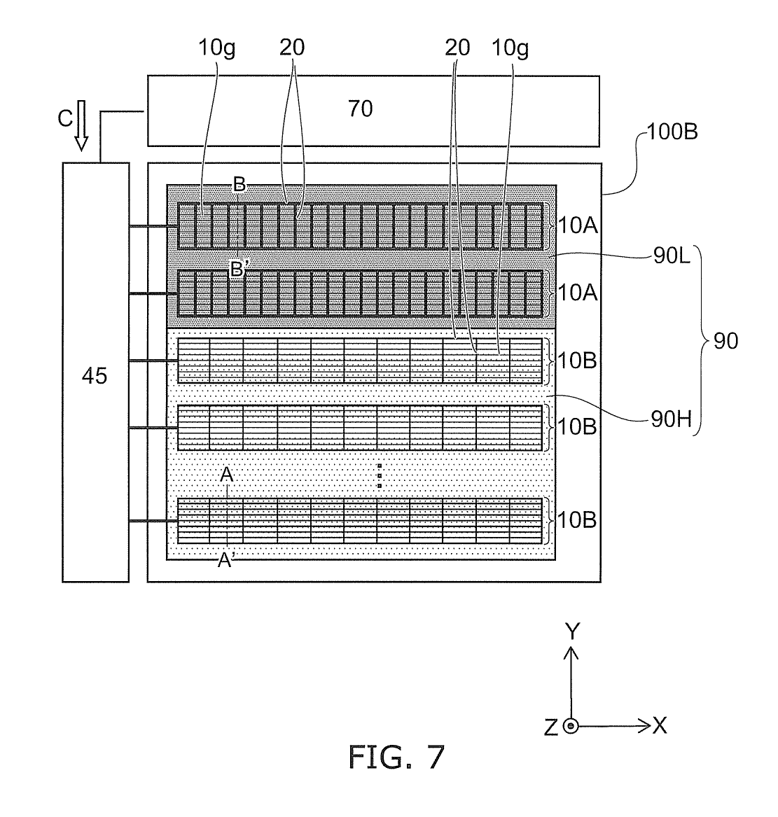

FIG. 7 is a plan view of a variation example of the semiconductor device according to this embodiment. Here, FIG. 7 shows an arrangement of multiple switching elements 10A and 10B.

For example, in a case where a control circuit 70 for controlling a driver circuit 45 is disposed near a region 90 on a substrate 15, as shown in FIG. 7, a region 90L in which the switching elements 10A each having a small absolute value of threshold voltage (Vth) are disposed may be disposed on the control circuit 70 side. A gate wiring 20 laid out in the region 90L has a width larger than a gate wiring 20 laid out in a region 90H having a large absolute value of threshold voltage (Vth). Further, the number of the gate wirings 20 in the region 90L is larger than that in the region 90H. Accordingly, a parasitic resistance (gate resistance Rg) of the gate wirings 20 laid out in the region 90L is smaller than that of the gate wirings 20 laid out in the region 90H.

According to the semiconductor device 100B described above, the region 90L in which the absolute value of the threshold voltage (Vth) of the switching elements is set to be small is disposed nearby the control circuit 70. Accordingly, injection of electronic current into the substrate 15 and the control circuit 70 is efficiently suppressed. Further, the gate resistance Rg of the switching elements in the region 90L is set to be lower than that in the region 90H, whereby self turn-on is suppressed. For this reason, the use of the semiconductor device 100B improves power conversion efficiency of the DC-DC converter.

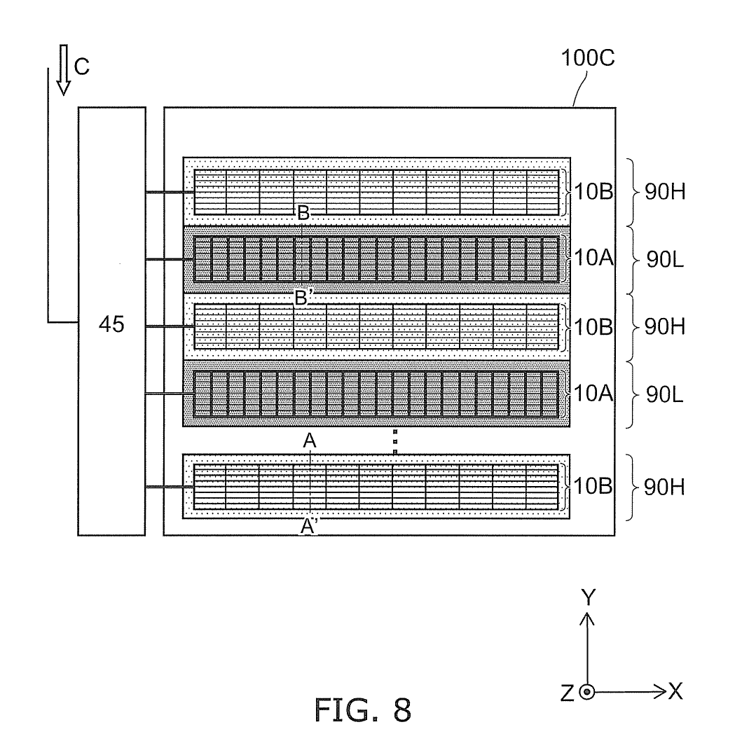

FIG. 8 is a plan view of a variation example of the semiconductor device according to this embodiment. Here, FIG. 8 shows an arrangement of multiple switching elements 10A and 10B.

As shown in FIG. 8, in a semiconductor device 100C, the switching element 10A having a small absolute value of threshold voltage (Vth) is disposed in regions 90L, and the switching element 10B having a large absolute value of threshold voltage (Vth) is disposed in regions 90H. The region 90L and the region 90H are, for example, alternately arranged in the Y direction.

A gate wiring 20 laid out in the region 90L has a width larger than the width of a gate wiring 20 laid out in a region 90H. Further, the number of the gate wirings 20 in the region 90L is larger than that in the region 90H. Accordingly, a parasitic resistance (gate resistance Rg) of the gate wirings 20 laid out in the region 90L is smaller than that of the gate wirings 20 laid out in the region 90H.

According to the semiconductor device 100C described above, the regions 90L in which the absolute value of the threshold voltage (Vth) of the switching elements is set to be small are arranged approximately evenly within the region 90. Accordingly, the total amount of electronic current to be injected into the substrate 15 within the region 90 is suppressed, and the electronic current spreads evenly in the region 90. Thus, injection of the electronic current into the driver circuit 45 can be suppressed. Further, the gate resistance Rg of the region 90L in which the absolute value of the threshold voltage (Vth) of the switching elements is set to be small is lower than that of the region 90H. Thereby, self turn-on is suppressed in the semiconductor device 100C. For this reason, the use of the semiconductor device 100C improves power conversion efficiency of the DC-DC converter.

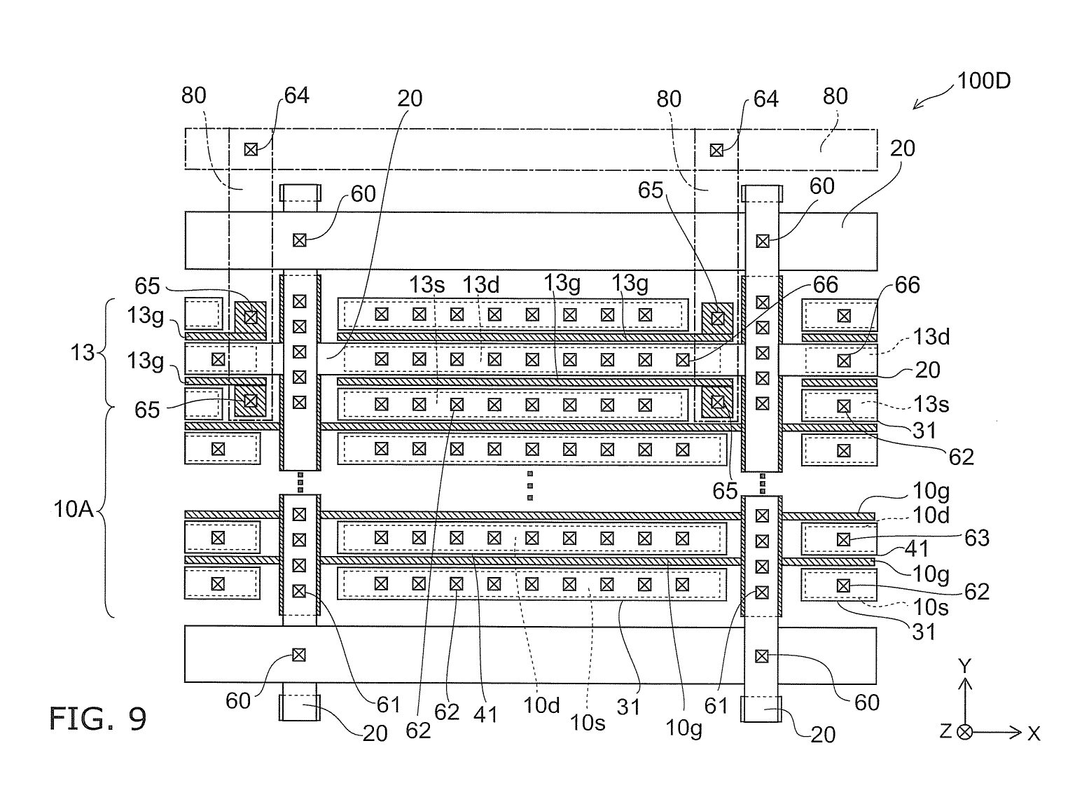

FIG. 9 is a main part plan view of a variation example of the semiconductor device according to this embodiment. FIG. 9 is, for example, a main part enlarged plan view of the switching elements 10A and the like in the region 90L shown in FIG. 4, FIG. 7, and FIG. 8. As shown in FIG. 9, a semiconductor device 100D includes N-channel switching elements 13 of a driver circuit 45 around a region 90 having multiple switching elements 10A disposed therein.

For example, gate wirings 20 are periodically laid out in the X direction of the semiconductor device 100D and in the Y direction approximately perpendicular to the X direction. The gate wirings 20 are electrically connected to each other through contact holes 60. Moreover, the gate wirings 20 extended in the Y direction are connected to gate electrodes 10g of the switching elements 10A through contact holes 61. The gate electrodes 10g extend in the X direction and are periodically disposed in the Y direction. A source region 10s and a drain region 10d of the switching element 10A are disposed on both sides of each of the gate electrodes 10g. A source electrode 31 is connected to the source region 10s through a contact hole 62. A drain electrode 41 is connected to the drain region 10d through a contact hole 63. In FIG. 9, the illustration of contact regions 10c is omitted.

Further, in addition to the gate wirings 20, gate wirings 80 are laid out in the X direction of the semiconductor device 100D and in the Y direction approximately perpendicular to the X direction. The gate wirings 80 laid out in the X direction and the Y direction are electrically connected to each other through contact holes 64. Moreover, the gate wirings 80 extended in the Y direction are connected to gate electrodes 13g of the switching elements 13 through contact holes 65. Similar to the gate electrodes 10g, the gate electrodes 13g extend in the X direction. A source region 13s and a drain region 13d of the switching element 13 are disposed on both sides of each of the gate electrodes 13g. The drain region 13d is connected to the gate wiring 20 laid out on the drain region 13d through a contact hole 66. That is, the drain region 13d of the switching element 13 and the gate wiring 20 of the semiconductor device 100D are electrically connected. A source electrode 31 is connected to the source region 13s through a contact hole 62.

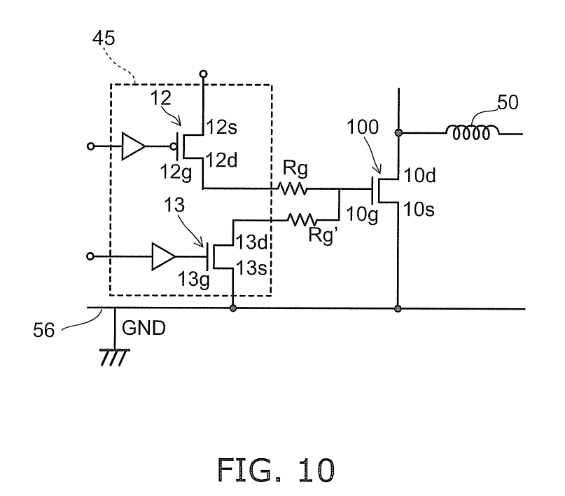

By including the N-channel switching element 13 of the driver circuit 45 in the region 90L having the switching elements 10A disposed therein, an equivalent circuit of the driver circuit 45 is realized as shown in FIG. 10. As shown in FIG. 10, a distance between the drain region 13d of the switching element 13 and the gate electrode 10g of the semiconductor device 100 serving as the switching element is shorter than a distance between the drain region 12d of the switching element 12 and the gate electrode 10g of the semiconductor device 100. Accordingly, a gate resistance Rg′ between the drain region 13d of the switching element 13 and the gate electrode 10g of the semiconductor device 100 is even smaller than the gate resistance Rg shown in FIG. 2C. As a result, self turn-on of the semiconductor device 100D is further suppressed.

Hereinabove, embodiments of the invention are described with reference to specific examples. However, the invention is not limited to these specific examples. That is, those skilled in the art can suitably make design change on any of the above specific examples, and such modifications are also encompassed within the scope of the embodiments as long as they include the features of the embodiments. For example, the respective constituents included in the specific examples described above, and arrangement, materials, conditions, shapes, sizes and the like thereof are not limited to those illustrated above, but can be appropriately modified. For example, embodiments of the invention may be diverted to a motor drive circuit using a coil as a load of an inductor connected to a switch node. Further, similar effects can be obtained with a structure in which the respective parts of a semiconductor configuring the MOSFET have inverted conductivity types.

In addition, the respective constituents included in the embodiments described above can be combined together within a technically achievable scope, and such a combination is also included in the scope of the embodiments as long as the combination includes the features of the embodiments.

Furthermore, those skilled in the art could conceive various modifications and alterations in the scope of the spirit of the embodiments. It shall be understood that such modifications and alterations pertain to the scope of the embodiments.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

1. A semiconductor device comprising:
a first switching element having a first threshold voltage and a first gate electrode connected to a first gate wiring; and
a second switching element having a second threshold voltage and a second gate electrode connected to a second gate wiring, the second threshold voltage having a larger absolute value than an absolute value of the first threshold voltage, the second gate wiring having a larger resistance per unit length than a resistance per unit length of the first gate wiring.

2. The device according to claim 1, wherein the first switching element and the second switching element are connected in parallel.

3. The device according to claim 1, wherein the first gate wiring is connected to the second gate wiring.

4. The device according to claim 1, wherein a built-in diode is provided in the first switching element and the second switching element.

5. The device according to claim 1, wherein a line width of the first gate wiring is larger than a line width of the second gate wiring.

6. The device according to claim 1, wherein
the first switching element is disposed in a first region,
the second switching element is disposed in a second region, and
the first region is adjacent to the second region.

7. The device according to claim 1, wherein
a gate electrode of the first switching element is periodically disposed in a direction approximately perpendicular to an extending direction of the gate electrode in a first region, and
the first switching element is disposed in the first region.

8. The device according to claim 7, wherein
a source region and a drain region of the first switching element are alternately arranged in the direction approximately perpendicular to the extending direction of the gate electrode in the first region, and
the first switching element is disposed in the first region.

9. The device according to claim 1, further comprising
a driver circuit driving the first switching element and the second switching element,
the first switching element being disposed closer to the driver circuit side than the second switching element.

10. The device according to claim 9, further comprising
a control circuit controlling the driver circuit,
the first switching element being disposed closer to the control circuit side than the second switching element.

11. The device according to claim 1, wherein
the first switching element is disposed in a first region,
the second switching element is disposed in a second region, and
the first region and the second region are alternately arranged.

12. The device according to claim 9, wherein
the driver circuit has a circuit,
a third switching element and a fourth switching element are connected in series in the circuit, and
a resistance per unit length of a wiring connecting the fourth switching element to a gate of the first switching element is smaller than a resistance per unit length of a wiring connecting the third switching element to the gate of the first switching element.

13. The device according to claim 12, wherein
the fourth switching element is provided around a first region, and
the first switching element is disposed in the first region.

14. A DC-DC converter comprising:
a low-side semiconductor device including:
a first switching element having a first threshold voltage and a first gate electrode connected to a first gate wiring; and
a second switching element having a second threshold voltage and a second gate electrode connected to a second gate wiring, the second threshold voltage having a larger absolute value than an absolute value of the first threshold voltage, the second gate wiring having a larger resistance per unit length than a resistance per unit length of the first gate wiring;
a fifth high-side switching element connected in series to the semiconductor device;
an inductor having one end side connected between the semiconductor device and the fifth switching element; and
a capacitor connected to one other end side of the inductor.

15. The converter according to claim 14, wherein the semiconductor device, the fifth switching element, and a driver circuit driving the semiconductor device and the fifth switching element are formed on a same substrate.
